(19) United States
(12) Patent Application Publication
(10) Pub. No.: US 2020/0184115 A1
(43) Pub. Date: Jun. 11, 2020

(54) Method and Apparatus for Operating a Computer

(71) Applicant: Ric B RICHARDSON, Coopers Shoot (AU)

(72) Inventor: Ric B RICHARDSON, Coopers Shoot (AU)

(21) Appl. No.: 16/636,914

(22) PCT Filed: Aug. 8, 2018
(86) PCT No.: PCT/AU2018/050838

§ 371 Date: Feb. 6, 2020

(30) Foreign Application Priority Data
Aug. 8, 2017 (AU) 2017903155
Aug. 9, 2017 (AU) 2017903180

(51) Int. Cl. G06F 21/78; G06F 21/56; G06F 21/51; G06F 21/57; G06F 21/64; G06F 21/60

(52) U.S. Cl. CPC G06F 21/78; G06F 21/567; G06F 21/51; G06F 2221/2141; G06F 21/64; G06F 21/602; G06F 2221/033; G06F 21/57

(57) ABSTRACT

A computer system comprising a processor in communication with a memory structure;

the processor retrieving and executing executable code stored in the memory structure thereby to process data stored in and retrieved from the memory structure; the memory structure including at least an area designated as an executable application code storage area and a separate area designated as a data storage area;

the executable application code storage area switchable by a memory state switch structure between at least a first state and a second state;

whereby in the first state the memory in the executable application code storage area is read enabled and write enabled;

whereby in the second state the memory in the executable application code storage area is read enabled and write disabled.

### TECHNICAL FIELD

The present invention relates to computing systems and, more particularly although not exclusively, to apparatus and methodologies for operation of memory structures within the computing systems.

### BACKGROUND

The problem of attack from malicious software is well known in the art. Typically an attacker gains control of a target computer and then loads malicious software on that computer to be run in order to perform malicious tasks. For example Ransomware is a type of malware that is loaded onto a target computer and starts encrypting the contents of the computer's storage with the aim of ransoming the owner to obtain a decryption key to undo the encryption.

A current way of stopping this from happening is to monitor the computer for any encryption activity and to try and stop the offending process before significant encryption or damage is done.

There are many types of malware including Trojans worms and unauthorised remote control software. Anti virus software typically looks for the presence of known or questionable executable applications and disabling or deleting them before they cause a problem.

Most of these problems would be addressed for many computing applications if executable applications were stored in and limited to read only storage space and any data storage or retention required by each application was restricted to data only writeable memory space where no executable applications could be launched. This configuration of computing storage would stop malicious applications from being loaded onto the computer and being executed. This capability however is not offered by today's computing platforms.

GB2230881A discloses hardware for implementing different access security levels in a computer system. The methodology is based on controlling dataflow to memory rather than controlling the inherent behavioural capability of the memory.

US2014/0229743A1 seeks to create a malware resistant architecture by providing a mechanism for separating a dataflow comprising comingled instructions and data so as to direct to the instructions to an instruction memory and the data to a data memory. The methodology for making the memory structures malware resistant comprises applying encryption to the instructions/data in the memory structures.

The described invention is designed to address these issues.

It is an object of the present invention to address or at least ameliorate some of the above disadvantages.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

Accordingly in one broad form of the invention there is provided a computer system comprising a processor in communication with a memory structure;

the processor retrieving and executing executable code stored in the memory structure thereby to process data stored in and retrieved from the memory structure; the memory structure including at least an area designated as an executable application code storage area and a separate area designated as a data storage area;
the executable application code storage area switchable by a memory state switch structure between at least a first state and a second state;
whereby in the first state the memory in the executable application code storage area is read enabled and write enabled;
whereby in the second state the memory in the executable application code storage area is read enabled and write disabled.

Preferably the executable application code is not permitted to be stored in the data storage area.

Preferably the executable application code is not permitted to be executed from the data storage area.

Preferably the executable application code storage area and the separate data storage area are located within the same memory structure.

Preferably the processor is a single processor.

Preferably the processor comprises at least a first processor and a second processor.

Preferably the computer system comprises multiple processors; each processor adapted to execute code adapted for predefined, separate tasks.

Preferably the processor performs the function of the memory state switch structure.

Preferably the executable application code is stored in a predetermined directory structure and the processor sets the read write status of the predetermined directory structure to read and write status during loading of the executable application code and then sets the read write status of the predetermined directory structure to read only status in order to permit execution of the executable application code by the one or more processors.

Preferably the memory status switch structure comprises a manually operable switch.

Preferably the memory state switch structure is located locally to the computer system.

Preferably the memory status switch structure is located remote from the computer system.

Preferably the processor executes a hash of the executable application code stored in the executable application code storage area and compares the hash with a previously stored hash value thereby to determine if the executable application code has been changed.

Preferably the processor executes the hash every time the executable application code is stored in the executable application code storage area.

Preferably the processor executes the hash at predetermined time intervals.

Preferably preparatory to use of the memory structure whilst the memory structure is in its second state a memory state test is conducted to confirm the memory is in a read only state.

In a further broad form of the invention there is provided a method of minimising introduction of malware into a computer system; the method comprising providing a memory structure for storage of executable code by a processor of the computer system; the memory structure switchable between a first state which permits the processor to write to and read from the memory structure and a second state which permits the processor to read from the memory structure but not write to the memory structure.

Preferably the executable application code is not permitted to be stored in the data storage area.

Preferably the function of changing the state of the memory is performed by the operating system kernel.

Preferably preparatory to use of the memory structure whilst the memory structure is in its second state a memory state test is conducted to confirm the memory is in a read only state.

Preferably a digital input/output device incorporating means to implement the method as described above.

Preferably the device implemented as a software application on a smart phone.

Preferably a medium storing code thereon which, when executed by a processor, effects the method as described above.

Preferably the medium of is a non-transitory medium.

Preferably a digital input/output device incorporating means to recognize a physiological feature preparatory to executing the executable in accordance with the method as described above.

Preferably the device implemented as a software application on a smart phone.

Preferably a digital input/output device incorporating means to implement the computer system as described above.

Preferably the device implemented as a software application on a smart phone.

Preferably a medium storing code thereon which, when executed by a processor, effects the computer system as described above.

Preferably the medium is a non-transitory medium.

Preferably a digital input/output device incorporating means to recognize a physiological feature preparatory to executing the executable in accordance with the computer system as described above.

Preferably the device implemented as a software application on a smart phone.

Preferably the computer system hardware is constituted as a Harvard architecture computer system.

Preferably the computer system hardware is constituted as a modified Harvard architecture computer system.

In a further broad form of the present invention there is provided in a computer system; the computer system hardware comprising a Harvard architecture computer system; a method of minimising introduction of malware into the computer system; the method comprising providing a memory structure for storage of executable code by a processor of the computer system; the memory structure switchable between a first state which permits the processor to write to and read from the memory structure and a second state which permits the processor to read from the memory structure but not write to the memory structure.

Preferably executable application code is not permitted to be stored in the data storage area.

Preferably the function of changing the state of the memory is performed by the operating system kernel.

Preferably preparatory to use of the memory structure whilst the memory structure is in its second state a memory state test is conducted to confirm the memory is in a read only state.

In a further broad form of the present invention there is provided in a computer system; the computer system hardware comprising a modified Harvard architecture computer system; a method of minimising introduction of malware into the computer system; the method comprising providing a memory structure for storage of executable code by a processor of the computer system; the memory structure switchable between a first state which permits the processor to write to and read from the memory structure and a second state which permits the processor to read from the memory structure but not write to the memory structure.

Preferably executable application code is not permitted to be stored in the data storage area.

Preferably the function of changing the state of the memory is performed by the operating system kernel.

Preferably preparatory to use of the memory structure whilst the memory structure is in its second state a memory state test is conducted to confirm the memory is in a read only state.

In a further broad form of the invention there is provided a computer system comprising a processor in communication with a memory structure;

the processor retrieving and executing executable code stored in the memory structure thereby to process data stored in and retrieved from the memory structure; the memory structure including at least an executable application code storage area and a separate data storage area;
the executable application code storage area switchable by a memory state switch structure between at least a first state and a second state;
whereby in the first state the memory in the executable application code storage area is read enabled and write enabled;
whereby in the second state the memory in the executable application code storage area is read enabled and write disabled.

Preferably the processor is a single processor.

Preferably the processor comprises at least a first processor and a second processor.

Preferably the computer system comprises multiple processors; each processor adapted to execute code adapted for predefined, separate tasks.

Preferably one of the processors performs the function of the memory state switch structure.

Preferably the memory status switch structure comprises a manually operable switch.

Preferably the memory state switch structure is located locally to the computer system.

Preferably the memory status switch structure is located remote from the computer system.

In a further broad form of the invention there is provided a method of minimising introduction of malware into a computer system; the method comprising providing a memory structure for storage of executable code by a processor of the computer system; the memory structure switchable between a first state which permits the processor to write to and read from the memory structure and a second state which permits the processor to read from the memory structure but not write to the memory structure.

### BRIEF DESCRIPTION OF DRAWINGS

Embodiments of the present invention will now be described with reference to the accompanying drawings wherein:

FIG. 1—existing writeable application storage configuration example;

FIG. 2—example embodiment of a secure computing storage configuration;

FIG. 3 is a block diagram of an example of a computing system structure in accordance with a further embodiment and;

FIGS. 4A and 4B are series of state diagrams illustrating stages in the operation of the computing system in accordance with the embodiment of FIG. 3.

FIGS. 5A and 5B are series of state diagrams illustrating stages in the operation of the computing system in accordance with a further embodiment.

### DESCRIPTION OF EMBODIMENTS

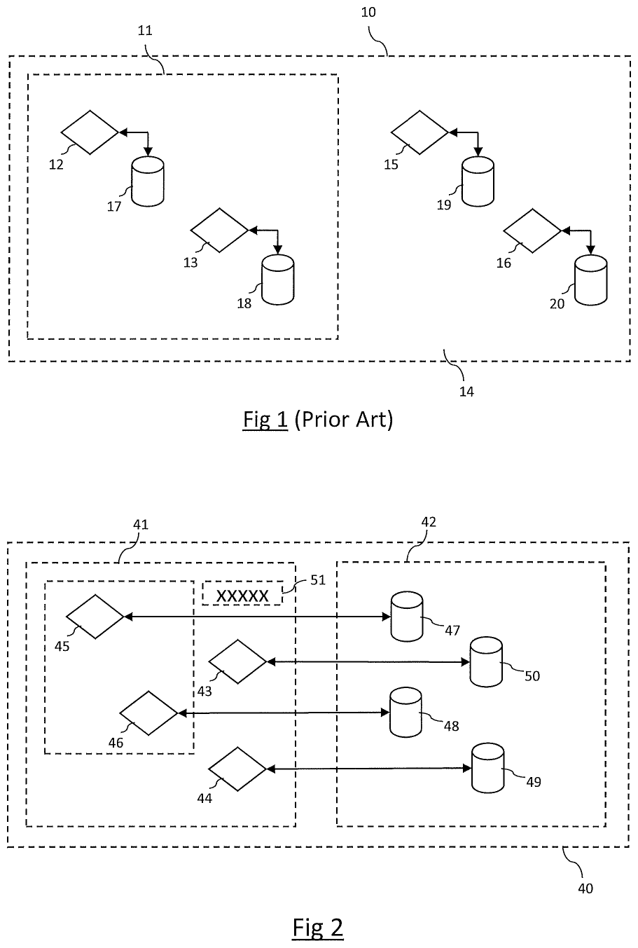

FIG. 1 shows an example of a standard writeable computer storage system 10. Typically the storage system 10 is all read writeable meaning that applications can be downloaded and stored to any part of the storage medium and that data can be read and written from any part of the storage media.

In a typical storage system an area of the storage 11 is set aside for applications 12 13 relating to the computers operating system, while in other parts of the storage 14 non operating system applications 15 16 are stored in readiness for execution by the computer to perform different tasks.

In each case the applications 12 13 15 16 may use read and writeable storage to store data 17 18 19 20 related to the applications 12 13 15 16 in order for the application to operate. For example logging data, state updates, user data and communications could be used by the great majority of applications.

A problem exists where the necessity of an application to access readable and writeable storage leaves an opportunity for an attacker to use the writeable storage space to load and run malicious software since all of the storage 10 can be used for application execution and writing of data.

FIG. 2 discloses the secure storage system of the example embodiment. The storage system 40 of the example embodiment contains two storage areas 41 42.

An executable application storage area 41 is only write enabled during initial application 43 44 and initial operating system 45 46 loading. Subsequently the executable application storage area 41 is write disabled so that no new applications can be added to storage in order to be executed.

These operating system applications 45 46 and other applications 43 44 must access related data files 47 48 49 50 and data storage capabilities that are in a data only storage area 42. This data only storage area 42 allows data to be written and read, but does not allow application data to be written, accessed or executed.

If an attacker obtains access to the computer, a storage system with this capability will not allow executeable applications to be stored to the data storage area or executed since the operating system has been modified to allow execution of applications only from storage space that is not writeable.

An additional security feature of the example embodiment could be a hash 51 of the application execution storage area 41 that is verified before any application is allowed to run. This hash 51 can be used to verify that the non writeable application storage area 41 has not been modified or altered thereby verifying the integrity of the applications stored at that location.

In the example embodiment a physical switch is used to switch the application execution storage space between writeable and non writeable or locked states. This means that a person must be physically at the computer to engage the storage writeable switch to allow the application execution storage area to be updated or modified.

### Further Embodiment

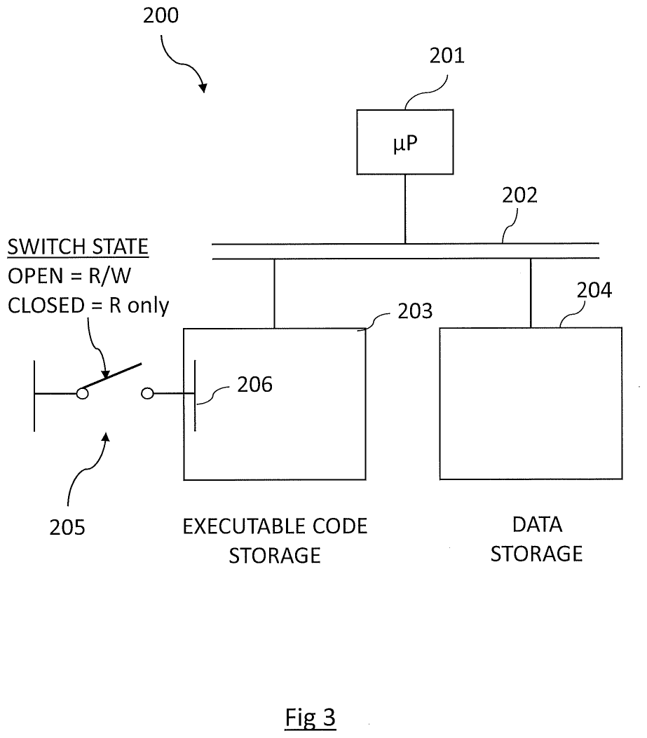

With reference to FIG. 3 there is illustrated a block diagram of a computing system 200 in accordance with a further embodiment.

In this instance, the computing system 200 comprises a processor 201 in communication with a bus 202 which is in communication with a first memory structure 203 and also in separate communication with a second memory structure 204.

In this instance, the first memory structure 203 is switchable between a first state and a second state by operation of a memory state switch apparatus 205.

In a first state the memory state switch apparatus 205 permits the first memory structure 203 to be written to and read by processor 201 via bus 202. In a second state the memory state switch apparatus 205 permits the first memory structure to be read by a processor 201 but not written to by processor 201.

The memory state switch apparatus 205 may be implemented as a single pole switch operating a memory bus 206 whereby in its open position memory bus 206 is in a first voltage state—for example 0 volts corresponding to the first state which permits the first memory structure 203 to be written to and read by processor 201 via bus 202. In second closed state the single pole switch applies a second voltage state to the memory bus 206—for example +5 volts which permits the first memory structure to be read by a processor 201 but not written to by processor 201.

### In Use

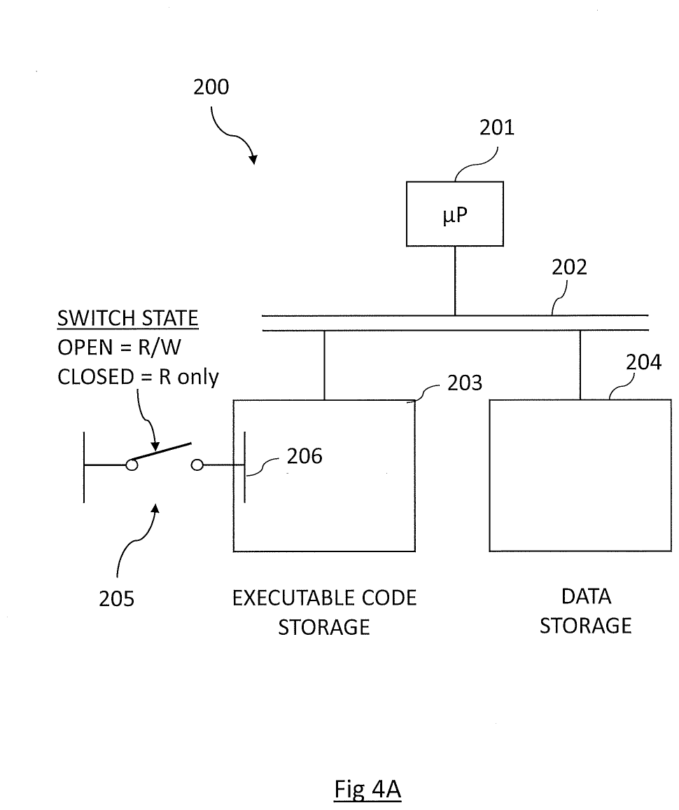

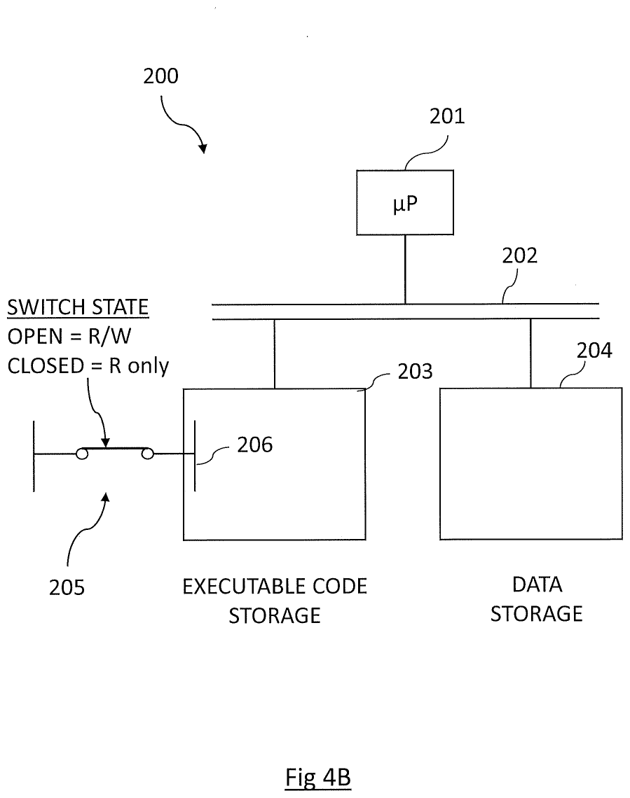

With reference to FIG. 4A, a processor 201 “boots up” and causes executable code to be loaded from permanent storage (for example ROM—not shown) whilst first memory structure 203 is in its first state.

Once fully loaded and with reference to FIG. 4B the first memory is switched to its second state by, in this instance, closing switch 205 whereby processor 201 is moved to its second state. In this state the processor 201 may execute or retrieve and execute instructions from first memory 203 but cannot change the instructions stored in first memory 203.

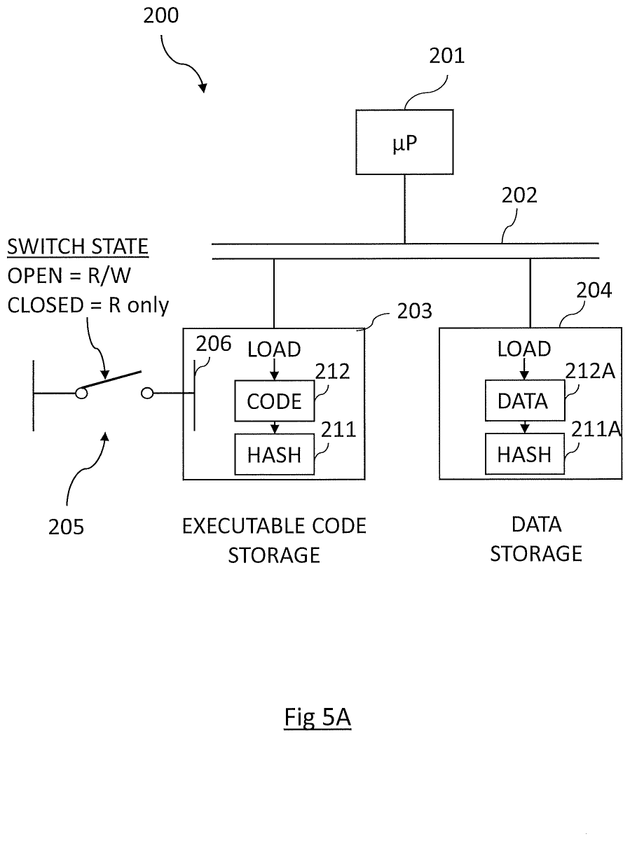

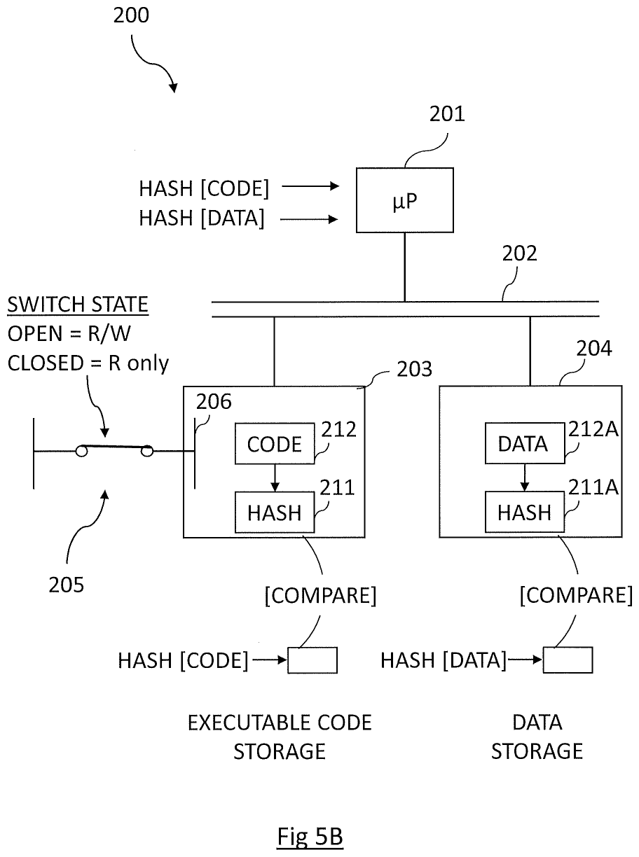

By way of further example and with reference to FIG. 5A, a processor 201 “boots up” and causes executable code to be loaded from permanent storage (for example ROM—not shown) whilst first memory structure 203 is in its first state. Prior to loading the code, a hash 211 of the code 212 may be made. The hash 211 may be stored for subsequent use.

Once fully loaded and with reference to FIG. 5B the first memory is switched to its second state by, in this instance, closing switch 205 whereby processor 201 is moved to its second state. In this state the processor 201 may execute or retrieve and execute instructions from first memory 203 including code 212. The processor 201 cannot change the instructions stored in first memory 203 whilst processor 201 is in its second state.

In FIG. 5B, in one form preparatory to processor 201 executing instructions including code 212 it will first form a hash of the code 212 and compare the hash value thus derived with hash 211 which was generated as part of the loading step of FIG. 5A. This is an active check step to ensure that the code 212 has not been amended or altered from the time of storage.

In a further preferred form, a similar check step capability can be arranged for the data storage whereby a hash 211A of data 212A is made at the time the data is first loaded into data storage 204. The check step can be performed by processor 201 prior to retrieval and use of the data 212A by the processor 201 performing a hash of data 212A and comparing the hash value thus derived with hash 211A.

In a further form once the system is in the state of FIG. 5B a test is conducted on the memory 203 to check if the memory 203 is in a writable state. If it is then the code is not loaded.

A similar memory state check for memory 204 can be undertaken preparatory to use of data stored in memory 204. The intention is to provide an additional check that the memory status, for whatever reason, has not been changed to a writable state thereby placing the code or data stored therein at risk.

Stated in another way for this embodiment preparatory to use of the memory structure whilst the memory structure is in its second state a memory state test is conducted to confirm the memory is in a read only state. The test may simply comprise the CPU transferring a block of data via the programme memory bus to the programme memory and determining whether the block of data can be read subsequent to the transfer.

### Alternative Embodiments

The example embodiment uses a physical switch to write enable and write disable the application execution area of the computer's storage. Such a capability may be advantageous in a device such as a modem or a router where the upgrades to the operating system are relatively rare and simple. An alternative embodiment could use a remote mode switch control that may or may not use the hash to verify any modification or tampering with the application storage space. Another embodiment could use firmware and related boot startup code that is not part of the storage system to switch between enabling the application storage space for read only or write enabled.

The example embodiment anticipates a computer storage system that is set to write enabled and write disable using operating system or control software. For example a hard drive that is writeable could be allocated some space that is made virtually un-writable by the operating system thereby stopping an attacker from installing and running applications.

Typically such a capability would involves a customised operating system kernel that would not allow applications to run if the application is running from storage space that is writeable.

In another alternative embodiment a cloud based computer system could be set to allow applications to be executable from only a specific directory on a storage system and where that directory is marked as non writeable by the operating system and then the contained applications are given access to data storage areas that are outside the write disabled directory. However areas outside the write disabled directory cannot be used for launching or initiating applications.

The example embodiment anticipates a hash calculation of the whole application and operating directory space to ensure there has been no unauthorised modification or addition to the device. An alternative embodiment could include a hierarchy or library of hashes to allow individual applications or groups of applications to be added to or removed from the device securely for use in read only memory mode.

The example embodiment anticipates an upgrade capability that only allows the application or operating system storage space to be written to when the device is in an upgrade mode and where only an upgrade application is allowed to run. The upgrade process though not described in this patent would no doubt include an install image checking capability to ensure the applications or executables to be installed are verified and not tampered with before installation which may involve restarting the device in memory writeable mode but only allowing an upgrade application to run after verifying the install image for integrity. The device would then be restarted in operating system and application memory read only mode for normal operation.

The above describes only some embodiments of the present invention and modifications, obvious to those skilled in the art, can be made thereto without departing from the scope of the present invention.

1. A computer system comprising a processor in communication with a memory structure;
the processor retrieving and executing executable code stored in the memory structure thereby to process data stored in and retrieved from the memory structure; the memory structure including at least an area designated as an executable application code storage area and a separate area designated as a data storage area;
the executable application code storage area switchable by a memory state switch structure between at least a first state and a second state;
whereby in the first state the memory in the executable application code storage area is read enabled and write enabled;
whereby in the second state the memory in the executable application code storage area is read enabled and write disabled.

2. The computer system of claim 1 wherein executable application code is not permitted to be stored in the data storage area.

3. The computer system of claim 1 wherein executable application code is not permitted to be executed from the data storage area.

4. The computer system of claim 1 wherein the executable application code storage area and the separate data storage area are located within the same memory structure.

5. The computer system of claim 1, wherein the processor is a single processor.

6. The computer system of claim 1, wherein the processor comprises at least a first processor and a second processor.

7. The computer system of claim 1, comprising multiple processors; each processor adapted to execute code adapted for predefined, separate tasks.

8. The computer system of claim 1, wherein the processor performs the function of the memory state switch structure.

9. The computer system of claim 1, wherein the executable application code is stored in a predetermined directory structure and the processor sets the read write status of the predetermined directory structure to read and write status during loading of the executable application code and then sets the read write status of the predetermined directory structure to read only status in order to permit execution of the executable application code by the one or more processors.

10. The computer system of claim 1, wherein the memory status switch structure comprises a manually operable switch.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A primary application loader of a computer operating system; wherein when the primary application loader receives a load request to load an application
a. the primary application loader checks that the application to be loaded into an execution memory of the computer operating system is being loaded from an approved storage location that has been previously authorised for the storage of approved applications;
i. the primary application loader performs a test to see if the approved storage location is in read only mode, meaning that the approved storage location must not be able to be written to;
ii. if the approved storage location can be written to then the load request is aborted;
b. if the application to be loaded into the execution memory is not from an approved storage location, then the loader aborts the load request.

44. The primary application loader of claim 43 wherein the loader further conducts a hash calculation on the location of the application to be loaded to detect if there have been any changes to the application or its folder components.

45. The primary application loader of claim 44 wherein if the hash has not changed, the application is allowed to run.

46. The primary application loader of claim 44 wherein if the hash has changed the load request is aborted.

47. The primary application loader of claim 44 wherein the hash calculation is applied to hashing of all combined approved storage location areas or any part thereof.

48. The primary application loader of claim 43 wherein a user is informed if the load request is aborted.

49. The primary application loader of claim 43 wherein a user is not informed if the load request is aborted.

50. The primary application loader of claim 43 wherein the loader does not have the ability to query an approved directory list, check for read only status of the approved storage location or conduct hash calculation on the location of the application to be loaded, but rather runs and executes separate systems applications to perform these tasks that in turn return control to the primary application loader before placing the application into memory.
